(19) United States
(12) Patent Application Publication
(10) Pub. No.: US 2023/0065776 A1
(43) Pub. Date: Mar. 2, 2023

(54) METHODS AND SYSTEMS FOR FACILITATING RESPONDING TO QUERIES ASSOCIATED WITH SPORTING EVENTS

(71) Applicant: Fanalyze, Inc., Roseville, CA (US)

(72) Inventor: Juan Juan, Roseville, CA (US)

(21) Appl. No.: 17/894,815

(22) Filed: Aug. 24, 2022

Related U.S. Application Data
(60) Provisional application No. 63/236,587, filed on Aug. 24, 2021.

(51) Int. Cl. G06F 40/56; G06F 16/33; G06F 16/338

(52) U.S. Cl. CPC G06F 40/56; G06F 16/3344; G06F 16/338

(57) ABSTRACT

Disclosed herein is a method of facilitating responding to queries associated with sporting events, in accordance with some embodiments. Accordingly, the method comprises receiving a query associated with a sporting event from a user device, analyzing the query using a natural language processing (NLP) model, identifying an intent associated with the query and a parameter associated with the intent based on the analyzing of the query, generating a database query for the query based on the intent and the parameter, retrieving a database associated with the sporting event based on the indication, executing a search in the database based on the database query, generating a search result for the search based on the executing, generating a response for the query using a natural language generation (NLG) model based on the search result and the query, and transmitting the response to the user device.

The current application claims a priority to the U.S. provisional patent application Ser. No. 63/236,587 filed on Aug. 24, 2021.

### FIELD OF THE INVENTION

Generally, the present disclosure relates to the field of data processing. More specifically, the present disclosure is methods and systems for facilitating responding to queries associated with sporting events.

### BACKGROUND OF THE INVENTION

The field of data processing is technologically important to several industries, business organizations, and/or individuals. In particular, the use of data processing is prevalent for fantasy sports platforms, prediction games, etc.

Sports league fans, sports betters, and fantasy football players all need to know information and statistics about the sports league teams and their players. Further, easily accessible, precise, and accurate data can help them make important decisions.

Existing techniques facilitating responding to queries associated with sporting events are deficient with regard to several aspects. For instance, current technologies require the user to navigate through many various pages to find the answer they are looking for and overwhelm them with unnecessary information. Furthermore, current technologies do not easily and accurately answer queries for ongoing sports events. Furthermore, current technologies do not provide precise answers for queries based on ongoing sports by voice. Moreover, current technologies only answer a limited range of basic questions related to sports leagues.

Therefore, there is a need for improved methods and systems for facilitating responding to queries associated with sporting events that may overcome one or more of the above-mentioned problems and/or limitations.

### SUMMARY OF THE INVENTION

This summary is provided to introduce a selection of concepts in a simplified form, which are further described below in the Detailed Description. This summary is not intended to identify key features or essential features of the claimed subject matter. Nor is this summary intended to be used to limit the claimed subject matter's scope.

Disclosed herein is a method of facilitating responding to queries associated with sporting events, in accordance with some embodiments. Accordingly, the method may include a step of receiving, using a communication device, at least one query associated with at least one sporting event from at least one user device associated with at least one user. Further, the method may include a step of analyzing, using a processing device, the at least one query using at least one natural language processing (NLP) model. Further, the method may include a step of identifying, using the processing device, at least one intent associated with the at least one query and at least one parameter associated with the at least one intent based on the analyzing of the at least one query. Further, the method may include a step of generating, using the processing device, at least one database query for the at least one query based on the at least one intent and the at least one parameter. Further, the method may include a step of retrieving, using a storage device, at least one database associated with the at least one sporting event based on the at least one indication. Further, the method may include a step of executing, using the processing device, at least one search in the at least one database based on the at least one database query. Further, the method may include a step of generating, using the processing device, at least one search result for the at least one search based on the executing. Further, the method may include a step of generating, using the processing device, at least one response for the at least one query using at least one natural language generation (NLG) model based on the at least one search result and the at least one query. Further, the method may include a step of transmitting, using the communication device, the at least one response to the at least one user device.

Further disclosed herein is a system for facilitating responding to queries associated with sporting events, in accordance with some embodiments. Accordingly, the system may include a communication device configured for receiving at least one query associated with at least one sporting event from at least one user device associated with at least one user. Further, the communication device may be configured for transmitting at least one response to the at least one user device. Further, the system may include a processing device configured for analyzing the at least one query using at least one natural language processing (NLP) model. Further, the processing device may be configured for identifying at least one intent associated with the at least one query and at least one parameter associated with the at least one intent based on the analyzing of the at least one query. Further, the processing device may be configured for generating at least one database query for the at least one query based on the at least one intent and the at least one parameter. Further, the processing device may be configured for executing at least one search in at least one database based on the at least one database query. Further, the processing device may be configured for generating at least one search result for the at least one search based on the executing. Further, the processing device may be configured for generating the at least one response for the at least one query using at least one natural language generation (NLG) model based on the at least one search result and the at least one query. Further, the system may include a storage device configured for retrieving the at least one database associated with the at least one sporting event based on the at least one indication.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flowchart of a method for facilitating responding to queries associated with sporting events, in accordance with some embodiments.

FIG. 3 is a flowchart of a method for facilitating determining a fulfillment status of intents of the queries associated with the sporting events, in accordance with some embodiments.

FIG. 4 is a flowchart of a method for facilitating identifying additional parameters for the intents of the queries associated with the sporting events, in accordance with some embodiments.

FIG. 5 is a block diagram of a system for facilitating responding to queries associated with sporting events, in accordance with some embodiments.

FIG. 6 is a block diagram of the system, in accordance with some embodiments.

FIG. 7 is a block diagram of the system, in accordance with some embodiments.

FIG. 8 is a block diagram of the system, in accordance with some embodiments.

FIG. 9 is a block diagram of the system, in accordance with some embodiments.

FIG. 10 is a block diagram of the system, in accordance with some embodiments.

FIG. 11 illustrates a home screen user interface of an application for facilitating responding to queries associated with sporting events, in accordance with some embodiments.

FIG. 12 illustrates a result user interface of the application, in accordance with some embodiments.

FIG. 13 illustrates a result user interface of the application, in accordance with some embodiments.

FIG. 14 illustrates a queries user interface of the application, in accordance with some embodiments.

FIG. 15 illustrates a slots user interface of the application, in accordance with some embodiments.

FIG. 16 illustrates a query search user interface of the application, in accordance with some embodiments.

FIG. 17 illustrates a user interface of the application, in accordance with some embodiments.

FIG. 18 illustrates a result user interface of the application, in accordance with some embodiments.

FIG. 19 illustrates a result user interface of the application, in accordance with some embodiments.

FIG. 20 illustrates a result user interface of the application, in accordance with some embodiments.

FIG. 21 illustrates a result user interface of the application, in accordance with some embodiments.

FIG. 22 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating providing sports game analysis based on text and speech queries, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g., a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g., username, password, passphrase, PIN, secret question, secret answer, etc.) and/or possession of a machine readable secret data (e.g., encryption key, decryption key, bar codes, etc.) and/or or possession of one or more embodied characteristics unique to the user (e.g., biometric variables such as, but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g., the server computer, a client device, etc.) corresponding to the performance of the one or more steps, environmental variables (e.g., temperature, humidity, pressure, wind speed, lighting, sound, etc.) associated with a device corresponding to the performance of the one or more steps, physical state and/or physiological state and/or psychological state of the user, physical state (e.g., motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g., a real-time clock), a location sensor (e.g., a GPS receiver, a GLONASS receiver, an indoor location sensor, etc.), a biometric sensor (e.g., a fingerprint sensor), an environmental variable sensor (e.g., temperature sensor, humidity sensor, pressure sensor, etc.) and a device state sensor (e.g., a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems for facilitating providing game analysis based on text and speech queries. Further, the disclosed methods and systems may facilitate providing pre-game, post-game, and in-game analysis of a game. Further, the disclosed system may provide in-game analysis for sports betting using search via text or speech. Further, a user may search for an in-game analysis with conversational queries using speech or text. For instance, the user may search a probability of a particular player Brady passing a touchdown during the first quarter. Furthermore, in an instance, the user may search who will have more passing yards, Brady or Mahomes. Further, the user may search which team will score first, Bucs or Chiefs. Further, in an instance, the user may search if a player will have more than 200 yards in this game.

Further, the disclosed systems may be associated with a software platform that may include but may not be limited to a software application and a website. Further, the software platform may provide a search box for typing or using voice queries. Further, the disclosed system may provide query results or analysis that may be displayed via text and voice.

Further, the disclosed system may be configured for receiving a search query. Further, the disclosed system may use database analysis (or database technology). Further, the disclosed system may be configured for generating output with analysis in text or audio/speech.

Further, the software platform may include an easy-to-use mobile application (or application) for an operating system that may include but may not be limited to Android, iOS, etc. Further, the software platform may answer detailed questions about players and teams of the game. Further, the game may include but may not be limited to NFL (or The National Football League), MLB (or Major League Baseball), NBA (or The National Basketball Association), etc. Further, in an instance, the mobile application may utilize Fanalyze's extensive NFL database from the 2020 season. Further, the queries (or questions) may be asked using either voice or text and may be answered using a combination of text, audio, and images. Further, asking questions by voice may save time for the user and may give the user an option for a more hands-free experience. Further, the mobile application may be limited to only a few different pages to quickly and easily give the user access to the answers to the questions the user may be looking for.

Further, in an instance, Fanalyze, an exemplary embodiment of the disclosed system herein, may include an accurate and thorough database of NFL teams, players, and games from the 2020 season. Further, the disclosed system may look through the information in Fanalyze's NFL database and break down the information into different types of questions the user may want to ask that may be answered using the data. Further, the database may be accessed by sending HTTP requests to Fanalyze's server and processing the responses.

Further, in an embodiment, the disclosed system may utilize advanced NLP models using an AI (or artificial intelligence) software application configured for building a conversational interface using voice and text. Further, the AI software application may be configured for designing, building, and deploying AI chatbots. Further, in an instance, the AI software application may include Amazon™ Lex allows the disclosed systems to utilize the same advanced natural language processing technology and handles all of the NLP models such as ASR, NLU, SLU, STT, and TTS. Further, the AI software application may be a well-established, highly supported, maintained, and easy-to-use service. Further, the AI software application scales automatically to meet the needs of the user (or client) as the user may wish to expand the application to more users.

Further, each type of question that the user might want to ask may be associated with intent. For example, a question about a player's age may correspond to the intent named PlayerProfileAge. Further, each intent may include a variety of sample utterances the AI software application uses to train the NLP models and determine the type of question the user may be asking. An example of a sample utterance for the PlayerProfileAge Intent may be ‘How old is playerName.’ Further, each intent may include a varying number of slots that correspond to the various input parameters needed from the user before a request from the user may be fully processed and a question may be answered. Further, the ‘The PlayerProfileAge’ intent may include a single slot, playerName. Further, the AI software application may continue to prompt the user until all necessary slot values for the request may be filled.

Further, in an instance, AWS Lambda functions may be used as code hooks with Node.js for both initialization and validation of user input as well as for the fulfillment of the queries asked by the user. Further, the AWS lambda functions may only run if triggered by a chatbot associated with the AI software application, so unnecessary use of resources and charges associated with the resources may be reduced.

Further, the AWS Lambda functions look at the values of the slots obtained from the user's input from the AI software application and determine the validity of the input, prompt the user for additional or different information if necessary, and perform some preprocessing on valid input so that the fulfillment lambda may extract the necessary information from Fanalyze's database/API? more easily. For example, spaces may be replaced with underscores and words like “average” are converted to “avg”. The fulfillment lambda uses the type of intent and slot values that have been validated and processed by the validation function from the AI software application to make the appropriate query of the database/API? It extracts the necessary information to answer the users' question (which is reflected by the type of intent), processes the data if necessary, and formats an output message with the answer for the user that gets sent back to the AI software application which then sends it to the mobile application to be displayed for the user.

Further, React Native may be used for the development of the app. We chose to use the React Native framework because of its cross-platform capabilities and popularity. Due to its popularity, it has vast support, and it should stay that way for the foreseeable future. This means that the mobile application should be relatively future-proof.

Further, to install this app for development purposes, React Native CLI, Yarn Package Manager, and an emulator (Android Studio/Xcode) are needed. In the root directory of the app run the command “yarn install” to install all of the project's dependencies. If developing for iOS, navigate to the “/ios” directory and run “pod install”. Now the dependencies may be downloaded in the directory “/node_modules” and the app may be ready to run. In the root directory run either “yarn react-native run-android” or “yarn react-native run-ios” to run the app on an Android or iOS emulator, respectively.

Some dependencies/libraries that the app uses may possibly become unsupported in the future and may cause errors. The libraries may need to be either manually updated or may be replaced entirely. However, the core functionality of the app mainly relies on core React Native libraries and an AWS library, so the app may be kept up to date easily. React Native is extensively documented online and so are the supporting libraries that the app uses. A quick Google search may provide plenty of support.

Further, if the AI software application answers a question unexpectedly or weirdly, the user may verify whether it is appropriately determining the Intent of your question as well as the Slot values by following these steps:
1. Navigate to the AI software application chatbot.
2. Navigate to the Intent in the “FanalyzeNFLMobileApp” the AI software application chatbot that the user thinks the question may be triggering.
3. Switch the “Fulfillment” heading from “AWS Lambda function” to “Return parameters to client”.
4. Click the “Build” button in the upper right-hand corner of the console and wait for the chatbot to build.
5. Ask the question again in the “Test Bot” area on the right-hand side of the screen. The Intent and Slot values may be displayed in the bottom half of the screen there.

Further, if a red error message like shown above appears in the console associated with the AI software application (in an instance, may be Lex console), something may be going on, potentially with the communication between Lex and AWS Lambda. First, wait a little bit and try refreshing the page and trying again. If the problem persists, to determine whether the problem may be coming from the initialization and validation lambda function follow these steps:
1. Locate the Intent that you are attempting to invoke when the error is produced.
2. Uncheck the “Initialization and validation code hook” box under “Lambda initialization and validation” for that Intent.
3. Click the “Build” button on the upper right-hand side of the console to rebuild the chatbot.
4. Test the bot by asking the same question again. If the error exists no more or changes, the problem may likely be coming from the initialization and validation lambda function. Follow the steps below for troubleshooting the Initialization and Validation Lambda function. When the issue may be resolved in AWS Lambda, be sure to reselect the box for “Initialization and validation code hook” again, rebuild the bot, and check that the error exists no longer occurring for that Intent. You do not need to follow steps 5 and 6. If the error still exists, recheck the “Initialization and validation code hook” box and switch the selection from “AWS Lambda Function” to “Return Parameters to Client” under the “Fulfillment” heading of that intent.
5. Build the chatbot again.
6. Ask the same question. If the error goes and the AI software application displays the expected slot values, the problem may likely be coming from the fulfillment function. Follow the steps below for troubleshooting the Fulfillment Lambda. When the issue may be resolved in AWS Lambda, be sure to reselect the box for “AWS Lambda Function” under “Fulfillment” again, rebuild the bot, and check that the error exists no longer occurring for that Intent.

Further, if the message “There was an error processing your request. Please try again or ask a different question.” appears, something in the fulfillment Lambda function may be producing a null or undefined result. If the user does not think this should be occurring, follow the steps in the section for debugging the Fulfillment Lambda below.

If something goes wrong with the fulfillment Lambda function, follow these steps to begin debugging:
1. Go to AWS Lambda.
2. Open the appropriate Lambda function.
3. Write a test that fits the Intent and Slot values you may be trying to use that produced the error. It may look something like the above. Give the test a name and click “Create”.
4. Run the test and see if you get the same response as you did from the AI software application console.
5. Comment out the line response_message=validate_message(response_message); at the end of the dispatch function in index.js.
6. Click the “Deploy” button.
7. Run the test again. You may now see the erroneous output that may be produced and corrected by validate_message and may continue debugging from there.
8. When you complete debugging and the test may be working properly, don't forget to uncomment the line response_message=validate_message(response_message);.
9. Finally, click the “Deploy” button to deploy your latest changes.

Further, the user may begin debugging the initialization and validation Lambda function by following these steps:
1. Go to AWS Lambda.
2. Open the appropriate Lambda function.
3. Configure a test event similar to the one shown above. Give the test a name and click “Create.”
4. Run the test and analyze the output.

Further, if other errors may be occurring and the suggestions may not solve the problem, AWS may include a lot of online support for all of its services including the AI software application and AWS Lambda. There may be also plenty of online support and documentation for JavaScript if that seems to be the source of the problem.

Further, Frequently Asked Questions may include:
What questions can I ask? See section 10 Supported Queries below or to see a list of supported queries from the mobile app, select an icon in the upper right-hand corner of the home screen.
How do I ask a question using text? Tap the search bar, type in your question, and press the search button.
How do I ask a question using my voice? Tap and hold the green microphone button while you speak your question out loud and then release the button.
How do I turn the output audio on/off? You can turn the output audio on or off by toggling the “Voice Response” switch in the lower right corner of the mobile app.
Where is the data coming from? This information is coming from Fanalyze's own NFL database.
When is the data from? The information is currently from the 2020 NFL season. You can also find this out by asking the app a question like “What season are these stats from?”

Further, the Android Studio is the official IDE for Google's Android operating system. It has an emulator feature that we use to test the React Native app.

Further, the Amazon™ Lex is an Amazon Web Service for creating conversational interfaces for external applications. Further, Amazon Web Services (AWS) is Amazon's cloud platform with many different services.

Further, Automatic Speech Recognition (ASR) is a component of SLU systems. In ASR, speech audio is taken as input and a stream of text without structure or punctuation may be produced as output. This is also referred to as Speech To Text (STT).

Further, the AWS Lambda is a serverless compute service that does not require any administration.

The libraries, support code that translates React Native code to native code (Android and iOS), that the app uses.

Further, the AI software application may be associated with the chatbot that consists of one or more unique Intents. Each Intent corresponds to a type of action the user might want to perform (in our case, the type of question they are asking). An Intent may consist of one or more Sample Utterances, zero or more Slots, an initialization and validation Lambda, and a fulfillment Lambda. Further, the National Football League (NFL) is “a professional American football league consisting of 32 teams, divided equally between the National Football Conference (NFC) and the American Football Conference (AFC)”. Further, Natural Language Processing (NLP) refers to the overall system that allows people and machines to communicate through written or spoken language. Further, Natural Language Understanding (NLU) is a subset of NLP. More specifically, it is the process of converting the user's natural, unpredictable input into a structured form that can be understood by a machine. Further, Node.js is an event-driven JavaScript runtime.

Further, React Native is an open-source, cross-platform mobile application development framework created by Facebook, Inc. It is the framework that we used to develop this app.

Further, each Intent has a variety of Sample Utterances that the AI software application uses to train its NLP models to determine what type of question the user is asking. An example of a Sample Utterance for the PlayerProfileAge Intent would be ‘How old is playerName.’

Further, the slot corresponds to a value needed as input from the user to fulfill an Intent in an AI software application chatbot and answer the user's question. A Slot consists of a slot name, a slot type, and a prompt message to elicit the value from the user if necessary. There can be zero or more Slots associated with each Intent. For example, the PlayerProfileAge Intent has a single Slot, with the slot name ‘playerName’, the slot type ‘AMAZON.athlete’, and the prompt message ‘Which player would you like to know about?’ to determine which player's age the user is asking about.

Further, spoken language often does not match the grammar of a language perfectly. There may be background noise, “umms”, or contractions mixed in with the input, complicating it. Spoken Language Understanding (SLU) tries to filter out these confusing elements to make sense of audio input.

Further, Text To Speech (TTS) is the process of converting text into natural, human-like audio.

Further, Apple's official IDE for developing its operating systems. It has a feature for emulating iOS, which we use for testing our React Native app for iOS. In Xcode, we initially had trouble finding the right simulator and the right package to install, which resulted in a stall in our progress and a delay in transporting the Android working app to the iOS side.

Further, Xcode may be easy to use for iOS integration and easy for testing and debugging on the iOS application. Further, Xcode may be associated with the Onerous installation process that takes up a huge amount of storage and plenty of packages to install. Further, the simulator associated with Xcode only runs on required packages.

Further, the AI software application may be associated with a straightforward interface. Further, the AI software application may be well integrated with the web app. Further, the AI software application may be associated with friendly testing and debugging environment and a well-organized system.

Further, the AI software application may be associated with a slight learning curve. Further, the AI software application may be needed to integrate with a web app. Further, the AI software application may need security credentials to log in each time. Further, the AI software application may be associated with limited programming languages.

Further, React Native may be associated with cross-platform and relatively similar to Javascript. Further, React Native did not work well on the iOS end and installation may be confusing. The technologies used had a learning curve and took us some time to figure out, but in the end, we were able to integrate them and create our app on both ends successfully.

Further, the AI software application may not include any licensing costs to use and deploy, but there may be a charge rate based on the number of queries serviced by AWS. This may be the main monetary cost involved. https://aws.amazon.com/lex/pricing/ “0.004 dollars per speech request and 0.00075 dollars per text request. For example, the cost for 1,000 speech requests would be 4.00 dollars, and 1,000 text requests would cost 0.75 dollars. The speech and text requests are added up at the end of the month to generate your monthly charges”.

Further, socially a working app may be available for NFL fans. The dataset is up-to-date with the latest NFL database. Users would only rely on their voice to retrieve their desired responses, which would be easy for folks who are not familiar with typing or feel like it is redundant to type. The drawbacks of the app would be that there won't be much interaction between the user and the app since it may be mostly questions and answers. All-access permissions may be given by the NFL database for the 2019-2020 season. The NFL is the sole owner of said database.

Further, Supported Queries associated with the disclosed system may include General Queries such as What season are these stats from?

Further, Supported Queries associated with the disclosed system may include Player Queries that may include comparison. Further, in an instance, the supported queries may include “Compare {playerName} and {playerName}. Ex: Compare Tom Brady and Aaron Rodgers.”. Further, Supported Queries associated with the disclosed system may be associated with Profile/About. Further, in an instance, the supported queries may be:
Where did {playerName} go to {schoolType}? Ex: Where did Tom Brady go to school?
When was {playerName} born? How old is {playerName}? Ex: How old is Tom Brady?
How much does {playerName} weigh? Ex: How much does Tom Brady weigh? How tall is {playerName}? Ex: How tall is Tom Brady?
What is {playerName} height and weight? Ex: What is Tom Brady's height and weight?
Where was {playerName} born? Ex: Where was Tom Brady born?
Where does {playerName} play? Who does {playerName} play for? What team is {playerName} on? Ex: What team is Tom Brady on?
When was {playerName} rookie year? Ex: When was Tom Brady's rookie year?
What is {playerName} jersey number? Ex: What is Tom Brady's jersey number?
What position does {playerName} play? Ex: What position does Tom Brady play?
What is {playerName} status? Ex: What is Tom Brady's status?
Further, the Supported Queries associated with the disclosed system may include Game Statistics. Further, in an instance, the supported queries associated with game statistics may be:
Where was {playerName} {gameNumber} game? Ex: Where was Tom Brady's fourth game?
Who was {playerName} {gameNumber} game against? Ex: Who was Tom Brady's second game against?
Who {outcomeType} {playerName} game in week {gameNumber}? Ex: Who won Tom Brady's game in week four?
How many {statCategory} {statType} did {playerName} get in the {gameNumber} game? (ex: How many passing touchdowns did Tom Brady get in the third game?) Ex: How many passing touchdowns did Tom Brady get in his third game?
How many {statCategory} {statType} and {statCategory} {statType} did {playerName} get in the {gameNumber} game? (ex: How many passing touchdowns did Tom Brady get in the third game?) Ex: How many passing touchdowns and rushing yards did Tom Brady get in his third game?
How many {teamStatType} did the {teamType} team have in {player—Name} {weekNumber} game? Ex: How many remaining timeouts did the home team have in Tom Brady's second game?
Further, the Supported Queries associated with the disclosed system may include seasonal Statistics. Further, in an instance, the supported queries associated with seasonal statistics may be:
How many {statCategory} {statType} did {playerName} have? Ex: How many passing hurries did Tom Brady have?
How many {statCategory} {statType} and {statCategory} {statType} did {playerName} have? Ex: How many passing touchdowns and rushing yards did Tom Brady have?
How many games did {playerName} {participationType} in? Ex: How many games did Tom Brady start in?
Further, the Supported Queries associated with the disclosed system may include team queries. Further, in an instance, the supported queries associated with team queries may include comparison queries. Further, in an instance, the comparison queries may include “Compare the {teamName} and the {teamName}. Ex: Compare the Broncos and the Colts.”
Further, in an instance, the supported queries associated with team queries may be associated with profile/about. Further, in an instance, the comparison queries may include:
What conference are the {teamName} in? Ex: What conference are the Broncos in?
What division are the {teamName} in? Ex: What division are the Broncos in?
Where do the {teamName} play? Ex: Where do the Broncos play?
Who is the {coachType} of the {teamName}? Who coaches the {team—Name}? Ex: Who is the defensive coordinator of the Broncos?
Further, in an instance, the supported queries associated with team queries may include game statistics queries. Further, in an instance, the game statistics queries may include:
Who was the {teamName} {weekNumber} game against? Ex: Who was the Broncos' second game against?
Where was the {teamName} {weekNumber} game? Ex: Where was the Broncos' third game?
Who {outcomeType} the {teamName} {weekNumber} game? Ex: Who won the Broncos' seventh game?
How many {statCategory} {statType} did the {teamName} have in their {weekNumber} game? Ex: How many rushing yards did the Broncos have in their tenth game?
Further, in an instance, the supported queries associated with team queries may include seasonal statistics queries. Further, in an instance, the seasonal statistics queries may include:
How many {statCategory} {statType} did the {teamName} have? Ex: How many passing touchdowns did the Broncos have?
Further, in an instance, the supported queries associated with team queries may include standing queries. Further, in an instance, the standing queries may include:
What is the {teamName} {recordCategory} record for {recordType}? Ex: What is the Broncos' division record for wins?
How many times did the {teamName} {outcomeType}? Ex: How many times did the Broncos win?
How many points did the {teamName} have this season? Ex: How many points did the Broncos score?
How many points were scored against the {teamName} this season? Ex: How many points were scored against the Broncos this season?
What is the {teamName} {rankType} rank? Ex: What is the Broncos' division rank?
What is the {teamName} win percentage? Ex: What is the Broncos' win percentage?
Further, a key associated with the supported queries for the possible values for each input variable:
coachType—{coach|head coach|defensive coordinator|offensive coordinator}
gameNumber—{first|second|third| . . . |eighteenth|nineteenth}
outcomeType—{wins|losses|ties|won|lost}
participationType—{start|play}
playerName—the NFL player's name
rankType—{points|conference|division}
recordCategory—{afc|conference|division|home|nfc|road}
recordType—{wins|losses|ties|win percentage|points for |points against}
schoolType—{school|college|university high school}
statCategory—{rushing|passing|fumbles}
statType—{yards|touchdowns|fumbles|hurries| . . . interceptions}
teamName—the NFL team given by just name, location, or both
teamStatType—{used timeout|remaining timeouts|points}
teamType—{home|away}

Further, the disclosed system may support queries that facilitate propositional bets. Further, the queries may include:
Which team will win the coin toss?
Will Patrick Mahomes pass over or under 255 yards?
Will Chiefs score in the fourth quarter?
Which team will get 10 points first?
Will Patrick Mahomes score over 2.5 Touchdowns?
Which team scores first?
Which team scores last?
Will the first score be a touchdown?
Will the last score be a touchdown?
Will someone score in the first 7 minutes?
Will the team that scores first win the game?
Will a safety be scored in the game?
Will total points be odd or even?
Which team makes a longer field goal?
Over/unders on total field goals made.
Spread bets on first downs made.
Will there be a 1-yard touchdown in the game?
Will there be a kickoff returned for a touchdown?
Will either team convert a 4th down?
1st turnover is a fumble?
1st turnover is an interception?
R. Bush pass receptions over/under 2.5.
Reggie Bush scores a touchdown?
Davone Bess pass receptions over/under 4.5
Davone Bess passing yards over/under 58.5.
K. Dansby solo+assisted tackles over/under 7.5.
Ryan Fitzpatrick TD passes over/under 1.5.
B. Hartline vs S. Johnson in receiving yards? Johnson+10.5
Reggie Bush vs CJ Spiller in rushing yards? CJ Spiller−10.5
Will opening kickoff be a touchback?
What will the first offensive play be?
Will there be a score in the first five minutes?
What will be the first score of game?
Will there be a score in last 3½ minutes of fourth quarter?
What team will score last in game?
The last score of game will be?
Last play of game will be a QB rush
More points will be scored in
Team to score longest TD
Will there be three unanswered scores in game
Successful two-point conversion in game
Both teams with a 35-yard or longer field goal
Largest lead in game
Will game be tied after 0-0
Total players with a pass attempt
Total net yards in game
Total third-down conversions in game
Successful fourth-down conversion
Total sacks by both teams
Total interceptions in game
Total punts in game
Will game go to overtime
Will team that scores last win game
Total match points odd or even
Further, the queries associated with over and under for stats may include:
Passing Yards
Passing TDS
Pass Completions
Pass Attempts
Interceptions
Longest Completion
Rushing Yards
Receptions
Receiving Yards
Rushing Attempts
Touchdowns
Total TDs in game
Longest TD scored in game
Shortest TD scored in game
Total field goals made in game
Longest made field goal
Shortest made field goal

Further, sample queries for the disclosed system may include tags, API category, query, and result.

Further, the present disclosure describes a method for facilitating providing in-game analysis based on text and speech queries. Accordingly, the method may include receiving, using a communication device, a game query associated with at least one sporting game from at least one user device associated with at least one user. Further, the game query may be associated with at least one sports, sports league, player, match, etc. Further, in an instance, the sports league may include NFL. Further, the game query may be associated with all major sports for professional and amateur leagues. Further, the at least one user may include an individual, an institution, and an organization that may want to analyze the at least one sporting game. Further, the at least one user device may include a smartphone, a laptop, a mobile, a personal computer, etc. Further, the game query may include a conversational query. Further, the game query may include at least one of speech or text. Further, the game query may be associated with fantasy sports and sports betting.

Further, the method may include retrieving, using a storage device, at least one machine learning algorithm. Further, the at least one machine learning algorithm may include a natural language processing algorithm.

Further, the method may include analyzing, using a processing device, the game query based on the at least one machine learning algorithm to generate a game query description. Further, the game query description may facilitate determining of the game query.

Further, the method may include retrieving, using the storage device, game data based on the game query description.

Further, the method may include analyzing, using the processing device, the game query description and game data to generate a game insight. Further, the game insight may provide analysis of the at least one sporting game corresponding to the game query. Further, the game insight may include a combination of text, audio, and images.

Further, the method may include transmitting, using the communication device, the game insight to the at least one user device.

Further, the method may include storing, using the storage device, the game query and the game insight.

Further, in some embodiments, the method may include receiving, using the communication device, live sports data from an input device. Further, the live sports data may be associated with a live gameplay of the at least one sporting game. Further, the live sports data may include live stream video, score, live sports data, etc. Further, the method may include analyzing, using the processing device, the live sports data. Further, the method may include generating, using the processing device, the game insight based on the analyzing of the live sports data.

In further embodiments, a system for facilitating providing in-game analysis based on text and speech queries is disclosed. Accordingly, the system may include a communication device configured for receiving a game query associated with at least one sporting game from at least one user device associated with at least one user. Further, the game query may be associated with at least one sport, sports league, player, match, etc. Further, the at least one user may include an individual, an institution, and an organization that may want to analyze the at least one sporting game. Further, the at least one user device may include a smartphone, a laptop, a mobile, a personal computer, etc. Further, the game query may include a conversational query. Further, the game query may include at least one of speech or text. Further, the game query may be associated with fantasy sports and sports betting. Further, the communication device may be configured for transmitting a game insight to the at least one user device.

Further, the system may include a processing device configured for analyzing the game query based on at least one machine learning algorithm to generate a game query description. Further, the game query description may facilitate determining of the game query. Further, the processing device may be configured for analyzing the game query description and game data to generate the game insight. Further, the game insight may provide analysis of the at least one sporting game corresponding to the game query.

Further, the system may include a storage device configured for retrieving the at least one machine learning algorithm. Further, the at least one machine learning algorithm may include a natural language processing algorithm. Further, the storage device may be configured for retrieving the game data based on the game query description. Further, the storage device may be configured for storing the game query and the game insight.

Further, the present disclosure describes an application that uses voice/text to search for information. Further, the application may be utilized primarily within the sports industry. Further, the application facilitates searches for players' or teams' stats, information, etc., and compares it to other players or teams.

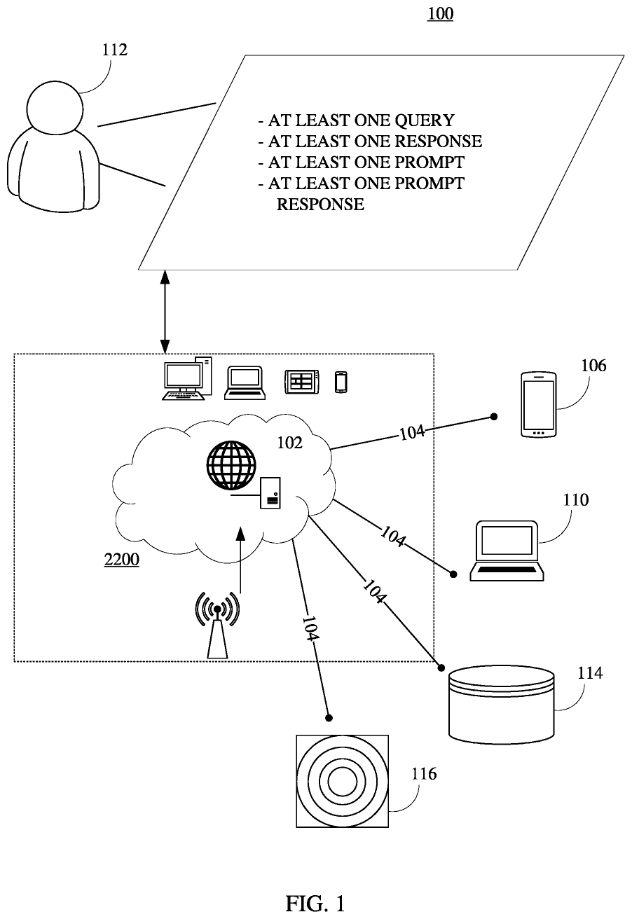

FIG. 1 is an illustration of an online platform 100 consistent with various embodiments of the present disclosure. By way of non-limiting example, the online platform 100 to facilitate providing sports game analysis based on text and speech queries may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 2200.

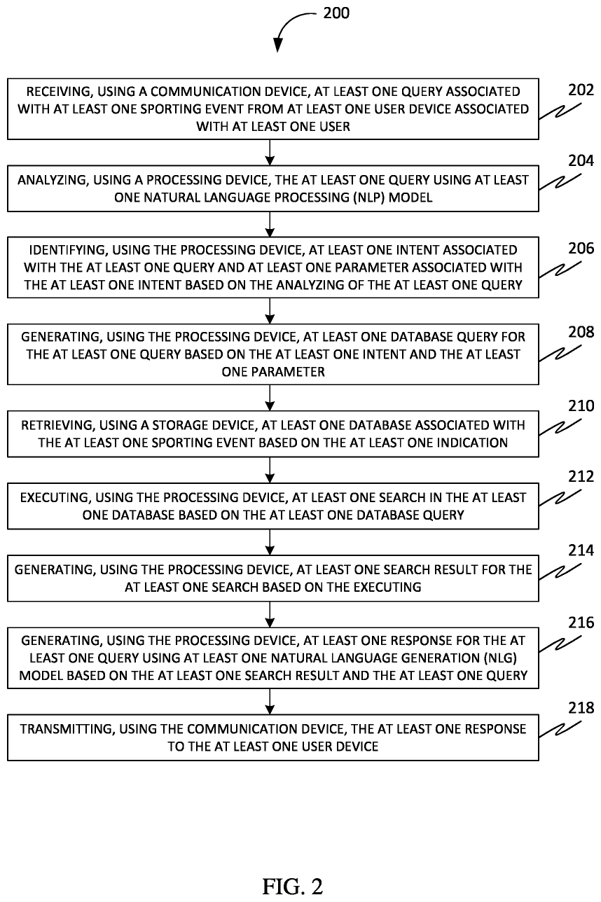

FIG. 2 is a flowchart of a method 200 for facilitating responding to queries associated with sporting events, in accordance with some embodiments.

Further, at 202, the method 200 may include receiving, using a communication device, at least one query associated with at least one sporting event from at least one user device associated with at least one user. Further, the at least one query may include at least one indication of the at least one sporting event. Further, the at least one user device may include smartwatches, VR Headsets, Kiosks, TVs, smartphones, etc. Further, the at least one user device, in an instance, may include a computing device, a client device, etc. Further, the at least one query may be the game query. Further, the at least one sporting event may be the sporting game.

Further, at 204, the method 200 may include analyzing, using a processing device, the at least one query using at least one natural language processing (NLP) model.

Further, at 206, the method 200 may include identifying, using the processing device, at least one intent associated with the at least one query and at least one parameter associated with the at least one intent based on the analyzing of the at least one query.

Further, at 208, the method 200 may include generating, using the processing device, at least one database query for the at least one query based on the at least one intent and the at least one parameter.

Further, at 210, the method 200 may include retrieving, using a storage device, at least one database associated with the at least one sporting event based on the at least one indication. Further, the at least one database may include the game data associated with the at least one sporting event, the live sports data associated with the at least one sporting event, etc.

Further, at 212, the method 200 may include executing, using the processing device, at least one search in the at least one database based on the at least one database query. Further, the at least one database may be searched using the at least one database query.

Further, at 214, the method 200 may include generating, using the processing device, at least one search result for the at least one search based on the executing.

Further, at 216, the method 200 may include generating, using the processing device, at least one response for the at least one query using at least one natural language generation (NLG) model based on the at least one search result and the at least one query. Further, the at least one response may include the game insight.

Further, at 218, the method 200 may include transmitting, using the communication device, the at least one response to the at least one user device.

Further, in some embodiments, the method 200 may include a step of analyzing, using the processing device, the at least one search result and the at least one query using at least one machine learning model. Further, the generating of the at least one response may be further based on the analyzing of the at least one search result and the at least one query.

Further, in an embodiment, the at least one query may include at least one assessment request associated with an occurrence of at least one future event in the at least one sporting event. Further, the method 200 may include predicting, using the processing device, a probability of occurrence of the at least one future event in the at least one sporting event based on the analyzing of the at least one search result and the at least one query using the at least one machine learning model. Further, the at least one machine learning model may be trained for predicting probability of occurrences for future events in the sporting events. Further, the probability of occurrence of the at least one future event in the at least one sporting event allows the at least one user to place at least one propositional bet on the at least one future event.

Further, in some embodiments, the at least one user device may include at least one microphone. Further, the at least one microphone may be configured for generating at least one voice query based on receiving at least one voice input from the at least one user. Further, the at least one query may include the at least one voice query. Further, the at least one user device may include a smartphone, a laptop, a desktop, a tablet computer, etc.

Further, in some embodiments, the at least one user device may include at least one input device. Further, the at least one input device may be configured for generating at least one textual query based on receiving at least one input from the at least one user. Further, the at least one query may include the at least one textual query. Further, the at least one input device may include a keypad, a keyboard, a touch-screen, etc.

Further, in some embodiments, the at least one user device may be configured for generating the at least one query based on at least one input from the at least one user. Further, the at least one user device may include at least one location sensor. Further, the at least one location sensor may be configured for generating the at least one indication of the at least one sporting event based on detecting a location of the at least one user device. Further, the generating of the at least one query may be further based on the generating of the at least one indication.

Further, in some embodiments, the at least one user device may be configured for generating the at least one query based on at least one input from the at least one user. Further, the at least one user device may be configured for generating the at least one indication for the at least one sporting event based on streaming at least one content associated with the at least one sporting event on the at least one user device. Further, the generating of the at least one query may be further based on the generating of the at least one indication.

Further, in some embodiments, the at least one response may include at least one voice response. Further, the at least one user device may include at least one speaker. Further, the at least one speaker may be configured for presenting the at least one voice response.

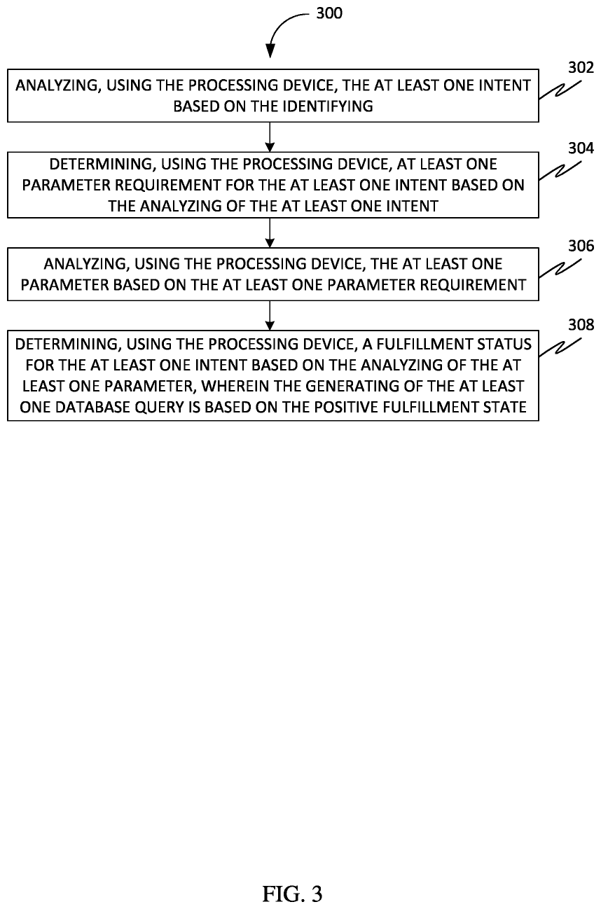

Further, in some embodiments, the at least one response may include at least one visual response. Further, the at least one user device may include at least one display device. Further, the at least one display device may be configured for displaying the at least one visual response. Further, the at least one display device may include a liquid-crystal display (or LCD), light-emitting diodes (or LED) display, organic light-emitting diodes (or OLED) display, active-matrix organic light-emitting diodes (or AMOLED) display, etc. FIG. 3 is a flowchart of a method 300 for facilitating determining a fulfillment status of intents of the queries associated with the sporting events, in accordance with some embodiments.

Further, at 302, the method 300 may include analyzing, using the processing device, the at least one intent based on the identifying.

Further, at 304, the method 300 may include determining, using the processing device, at least one parameter requirement for the at least one intent based on the analyzing of the at least one intent. Further, the at least one parameter requirement may include a number of parameters required for the at least one intent, a type of parameter required for the at least one intent.

Further, at 306, the method 300 may include analyzing, using the processing device, the at least one parameter based on the at least one parameter requirement.

Further, at 308, the method 300 may include determining, using the processing device, a fulfillment status for the at least one intent based on the analyzing of the at least one parameter. Further, the fulfillment status may include a positive fulfillment status and a negative fulfillment status. Further, the generating of the at least one database query may be further based on the positive fulfillment state. Further, the fulfillment status may indicate whether the at least one parameter fulfilled the at least one parameter requirement. Further, the positive fulfillment status indicates that the at least one parameter fulfills the at least one parameter requirement. Further, the negative fulfillment status indicates that the at least one parameter does not fulfill the at least one parameter requirement.

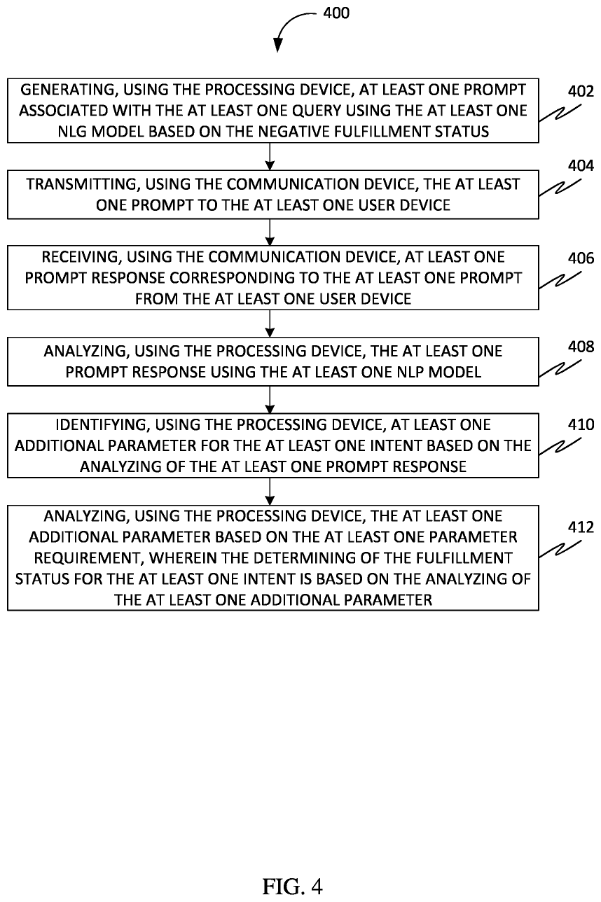

FIG. 4 is a flowchart of a method 400 for facilitating identifying additional parameters for the intents of the queries associated with the sporting events, in accordance with some embodiments.

Further, at 402, the method 400 may include generating, using the processing device, at least one prompt associated with the at least one query using the at least one NLG model based on the negative fulfillment status.

Further, at 404, the method 400 may include transmitting, using the communication device, the at least one prompt to the at least one user device.

Further, at 406, the method 400 may include receiving, using the communication device, at least one prompt response corresponding to the at least one prompt from the at least one user device.

Further, at 408, the method 400 may include analyzing, using the processing device, the at least one prompt response using the at least one NLP model.

Further, at 410, the method 400 may include identifying, using the processing device, at least one additional parameter for the at least one intent based on the analyzing of the at least one prompt response.

Further, at 412, the method 400 may include analyzing, using the processing device, the at least one additional parameter based on the at least one parameter requirement. Further, the determining of the fulfillment status for the at least one intent may be further based on the analyzing of the at least one additional parameter.

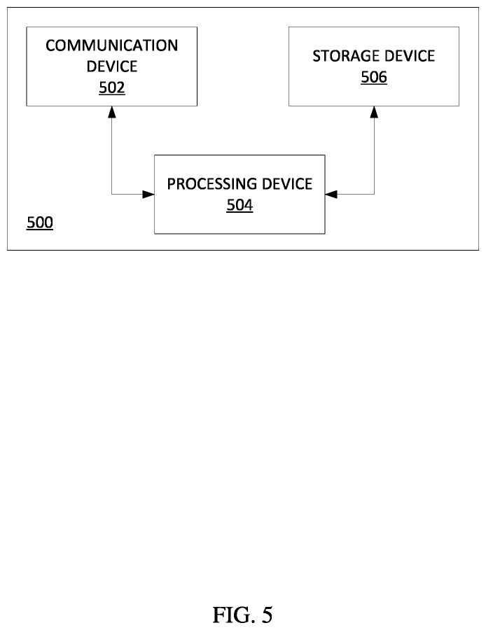

FIG. 5 is a block diagram of a system 500 for facilitating responding to queries associated with sporting events, in accordance with some embodiments. Accordingly, the system 500 may include a communication device 502, a processing device 504, and a storage device 506.

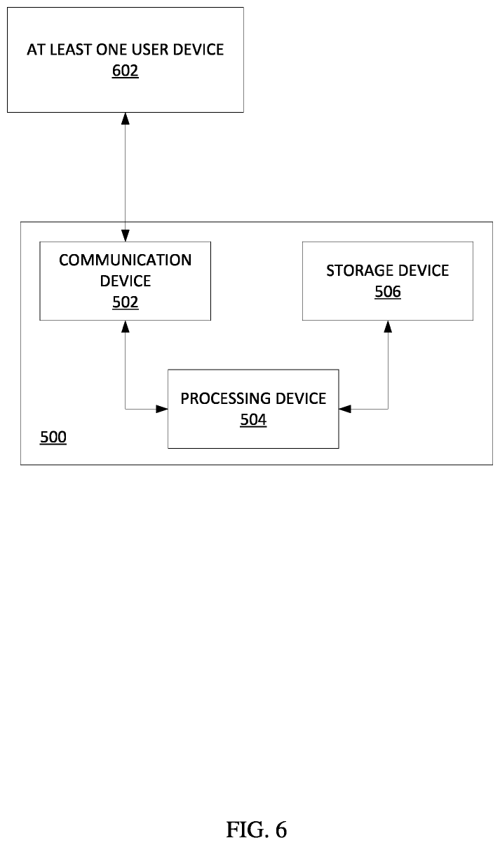

Further, the communication device 502 may be configured for receiving at least one query associated with at least one sporting event from at least one user device 602, as shown in FIG. 6, associated with at least one user. Further, the at least one query may include at least one indication of the at least one sporting event. Further, the communication device 502 may be configured for transmitting at least one response to the at least one user device 602.

Further, the processing device 504 may be communicatively coupled with the communication device 502. Further, the processing device 504 may be configured for analyzing the at least one query using at least one natural language processing (NLP) model. Further, the processing device 504 may be configured for identifying at least one intent associated with the at least one query and at least one parameter associated with the at least one intent based on the analyzing of the at least one query. Further, the processing device 504 may be configured for generating at least one database query for the at least one query based on the at least one intent and the at least one parameter. Further, the processing device 504 may be configured for executing at least one search in at least one database based on the at least one database query. Further, the processing device 504 may be configured for generating at least one search result for the at least one search based on the executing. Further, the processing device 504 may be configured for generating the at least one response for the at least one query using at least one natural language generation (NLG) model based on the at least one search result and the at least one query.

Further, the storage device 506 may be communicatively coupled with the processing device 504. Further, the storage device 506 may be configured for retrieving the at least one database associated with the at least one sporting event based on the at least one indication.

Further, in some embodiments, the processing device 504 may be further configured for analyzing the at least one intent based on the identifying. Further, the processing device 504 may be configured for determining at least one parameter requirement for the at least one intent based on the analyzing of the at least one intent. Further, the processing device 504 may be configured for analyzing the at least one parameter based on the at least one parameter requirement. Further, the processing device 504 may be configured for determining a fulfillment status for the at least one intent based on the analyzing of the at least one parameter. Further, the fulfillment status may include a positive fulfillment status and a negative fulfillment status. Further, the generating of the at least one database query may be further based on the positive fulfillment state.

Further, in some embodiments, the processing device 504 may be further configured for generating at least one prompt associated with the at least one query using the at least one NLG model based on the negative fulfillment status. Further, the processing device 504 may be configured for analyzing at least one prompt response using the at least one NLP model. Further, the processing device 504 may be configured for identifying at least one additional parameter for the at least one intent based on the analyzing of the at least one prompt response. Further, the processing device 504 may be configured for analyzing the at least one additional parameter based on the at least one parameter requirement. Further, the determining of the fulfillment status for the at least one intent may be further based on the analyzing of the at least one additional parameter. Further, the communication device 502 may be further configured for transmitting the at least one prompt to the at least one user device 602. Further, the communication device 502 may be configured for receiving the at least one prompt response corresponding to the at least one prompt from the at least one user device 602.

Further, in some embodiments, the processing device 504 may be further configured for analyzing the at least one search result and the at least one query using at least one machine learning model. Further, the generating of the at least one response may be further based on the analyzing of the at least one search result and the at least one query.

Further, in an embodiment, the at least one query may include at least one assessment request associated with an occurrence of at least one future event in the at least one sporting event. Further, the processing device 504 may be configured for predicting a probability of occurrence of the at least one future event in the at least one sporting event based on the analyzing of the at least one search result and the at least one query using the at least one machine learning model. Further, the at least one machine learning model may be trained for predicting probability of occurrences for future events in the sporting events. Further, the probability of occurrence of the at least one future event in the at least one sporting event allows the at least one user to place at least one propositional bet on the at least one future event.

Further, in some embodiments, the at least one user device 602 may include at least one microphone. Further, the at least one microphone may be configured for generating at least one voice query based on receiving at least one voice input from the at least one user. Further, the at least one query may include the at least one voice query.

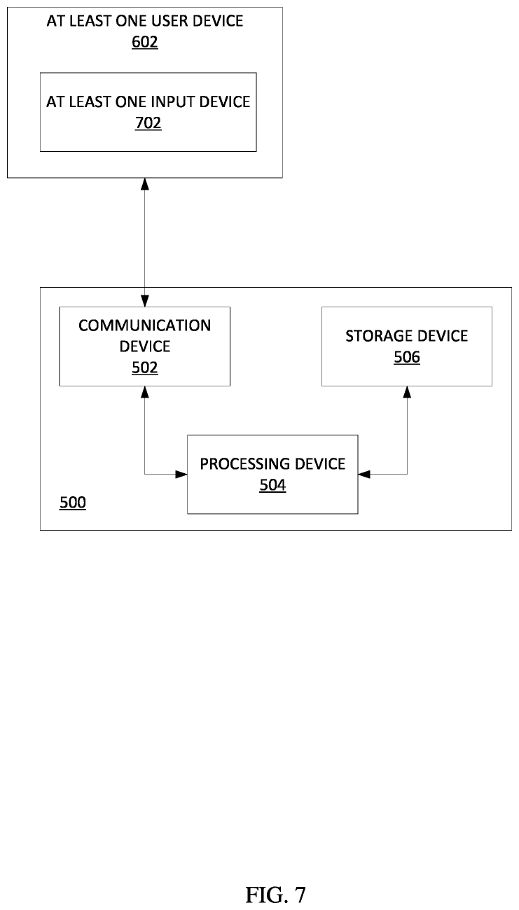

Further, in some embodiments, the at least one user device 602 may include at least one input device 702, as shown in FIG. 7. Further, the at least one input device 702 may be configured for generating at least one textual query based on receiving at least one input from the at least one user. Further, the at least one query may include the at least one textual query. Further, the at least one input device 702 may include a keypad, a keyboard, a touch-screen, etc.

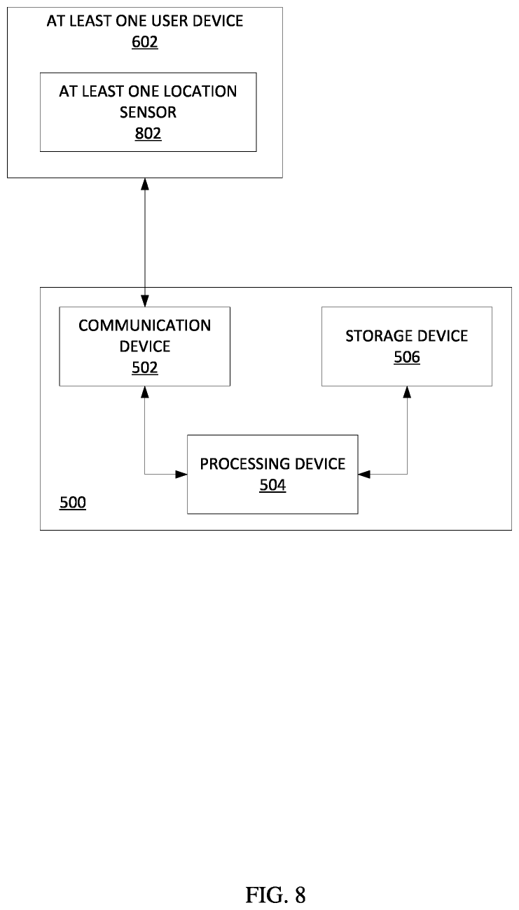

Further, in some embodiments, the at least one user device 602 may be configured for generating the at least one query based on at least one input from the at least one user. Further, the at least one user device 602 may include at least one location sensor 802, as shown in FIG. 8. Further, the at least one location sensor 802 may be configured for generating the at least one indication of the at least one sporting event based on detecting a location of the at least one user device 602. Further, the generating of the at least one query may be further based on the generating of the at least one indication.

Further, in some embodiments, the at least one user device 602 may be configured for generating the at least one query based on at least one input from the at least one user. Further, the at least one user device 602 may be configured for generating the at least one indication for the at least one sporting event based on streaming at least one content associated with the at least one sporting event on the at least one user device 602. Further, the generating of the at least one query may be further based on the generating of the at least one indication.

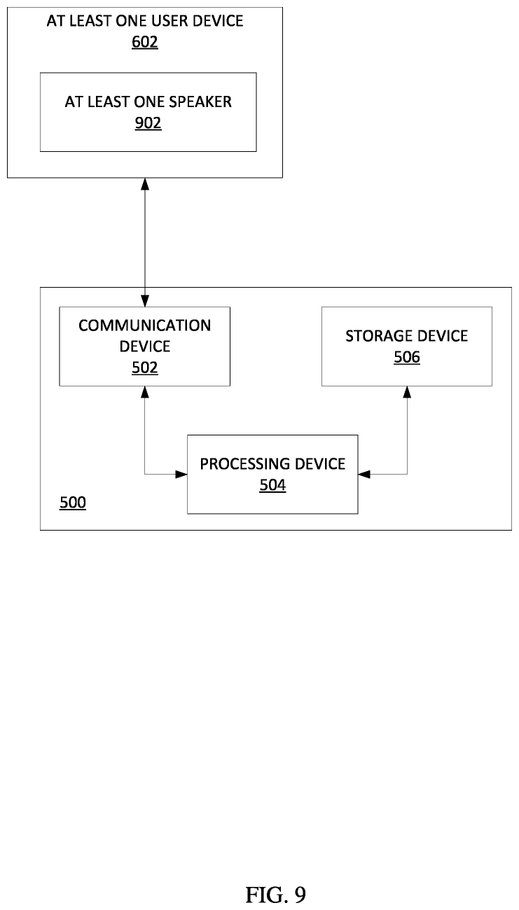

Further, in some embodiments, the at least one response may include at least one voice response. Further, the at least one user device 602 may include at least one speaker 902, as shown in FIG. 9. Further, the at least one speaker 902 may be configured for presenting the at least one voice response.

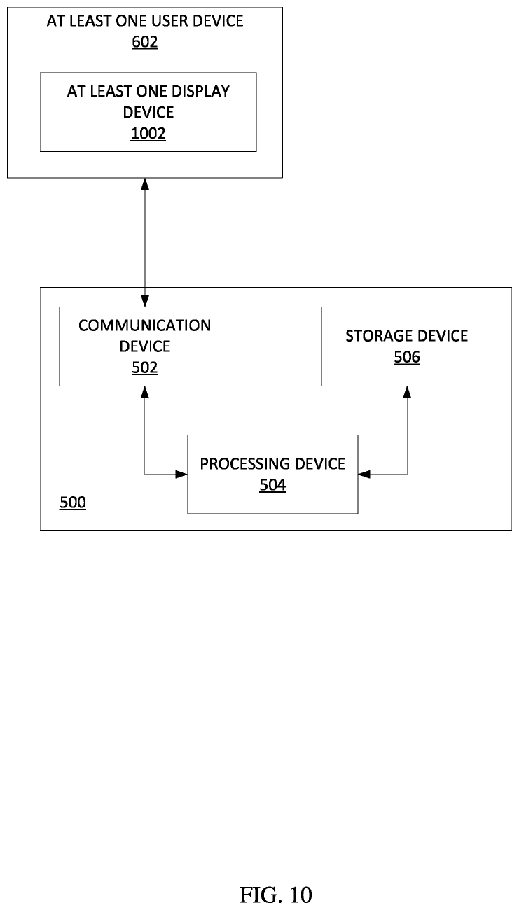

Further, in some embodiments, the at least one response may include at least one visual response. Further, the at least one user device 602 may include at least one display device 1002, as shown in FIG. 10. Further, the at least one display device 1002 may be configured for displaying the at least one visual response. Further, the at least one display device 1002 may include a liquid-crystal display (or LCD), light-emitting diodes (or LED) display, organic light-emitting diodes (or OLED) display, active-matrix organic light-emitting diodes (or AMOLED) display, etc.

FIG. 6 is a block diagram of the system 500, in accordance with some embodiments.

FIG. 7 is a block diagram of the system 500, in accordance with some embodiments.

FIG. 8 is a block diagram of the system 500, in accordance with some embodiments.

FIG. 9 is a block diagram of the system 500, in accordance with some embodiments.

FIG. 10 is a block diagram of the system 500, in accordance with some embodiments.

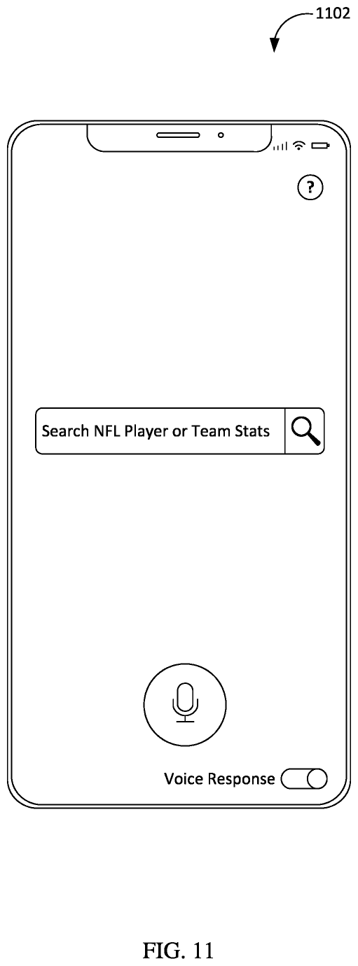

FIG. 11 illustrates a home screen user interface 1102 of an application for facilitating responding to queries associated with sporting events, in accordance with some embodiments. Further, in some embodiments, the application may be Fanalyze. Further, the home screen user interface 1102 may include a search bar is where the user can type in a query. Then the query is submitted by either clicking the button with the search icon or by clicking submit/enter on the keyboard. Further, the home screen user interface 1102 may include a button with the microphone icon that may be held down while the user is asking a voice query into their phone's microphone and released when done asking. Further, the home screen user interface 1102 may include a button on the bottom right to enable or disable the app's voice response feature. It is on by default. Further, the home screen user interface 1102 may include a button with a question mark on the top right, takes the user to the Queries Page, which shows the supported queries.

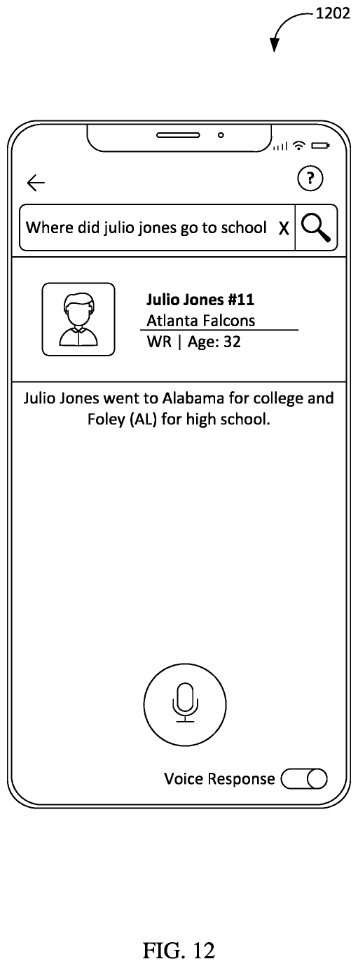

FIG. 12 illustrates a result user interface 1202 of the application, in accordance with some embodiments.

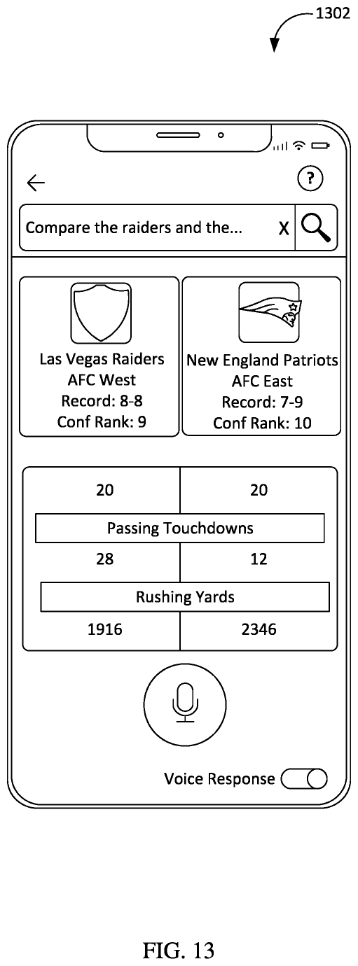

FIG. 13 illustrates a result user interface 1302 of the application, in accordance with some embodiments. Accordingly, the result user interface 1302 displays the answer to the user's query. If the query is not a comparison, the result user interface 1302 will look like that in FIG. 12. If the query was a comparison, the result user interface 1302 may look like FIG. 13. For comparisons, e.g., figure (b), the rectangle with stats is scroll-able. Further, the only new button is the back button on the top left. This button takes the user back to the home screen user interface 1102. The rest of the buttons retain the same functionality as explained in the home screen user interface 1102.

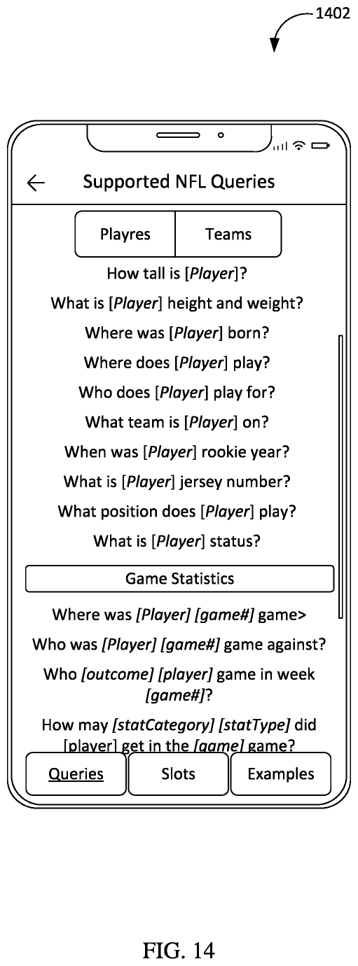

FIG. 14 illustrates a queries user interface 1402 of the application, in accordance with some embodiments.

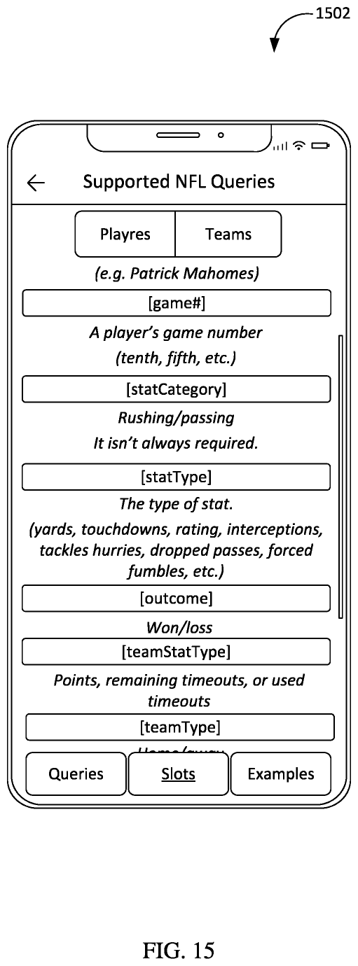

FIG. 15 illustrates a slots user interface 1502 of the application, in accordance with some embodiments. Accordingly, the queries user interface 1402 shows a list of supported queries with the slots, [ ], being the main and diversifying aspects of the queries. The Players/Teams buttons on top switch the queries between queries about players and teams. Further, the queries user interface 1402 may include a Queries button on the bottom that shows supported queries with slots. Further, the queries user interface 1402 may include a Slots button that explains what can go into the slots. Further, the queries user interface 1402 may include an Examples button that shows example queries. Further, the queries user interface 1402 may include a back button on the top left that takes the user back to the previous page; being either the home screen user interface 1102 or result user interface 1302.

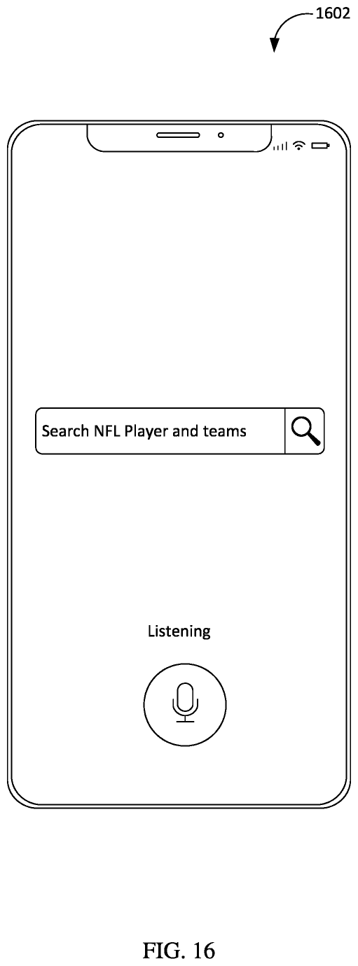

FIG. 16 illustrates a query search user interface 1602 of the application, in accordance with some embodiments.

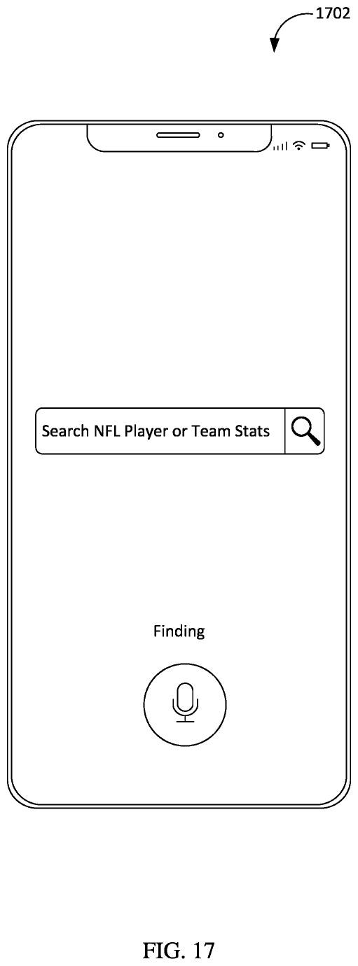

FIG. 17 illustrates a user interface 1702 of the application, in accordance with some embodiments.

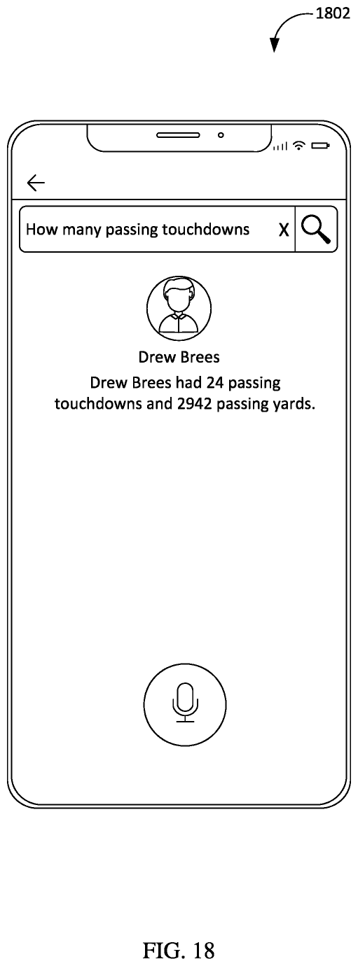

FIG. 18 illustrates a result user interface 1802 of the application, in accordance with some embodiments.

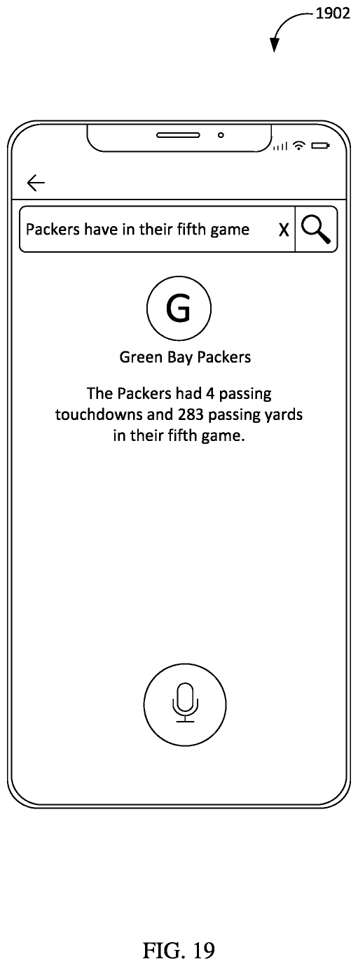

FIG. 19 illustrates a result user interface 1902 of the application, in accordance with some embodiments.

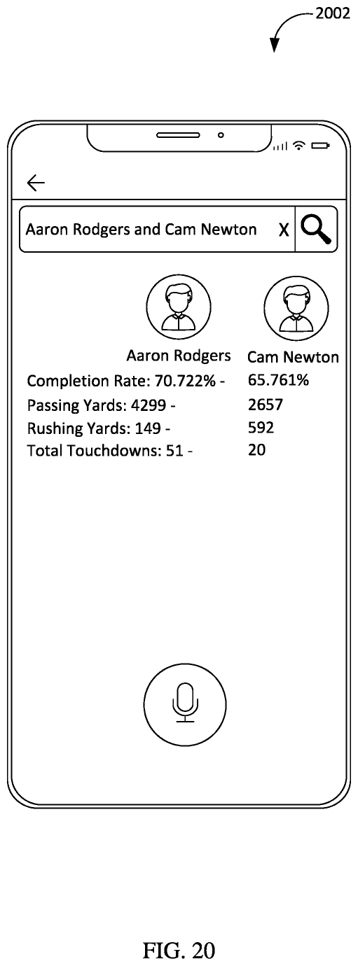

FIG. 20 illustrates a result user interface 2002 of the application, in accordance with some embodiments.

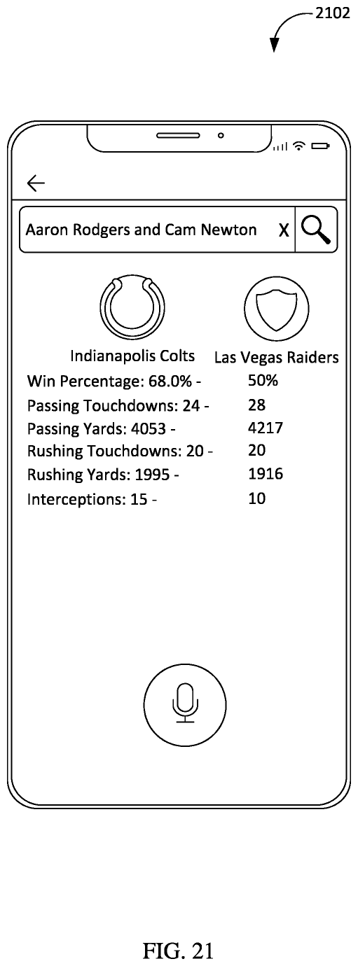

FIG. 21 illustrates a result user interface 2102 of the application, in accordance with some embodiments.

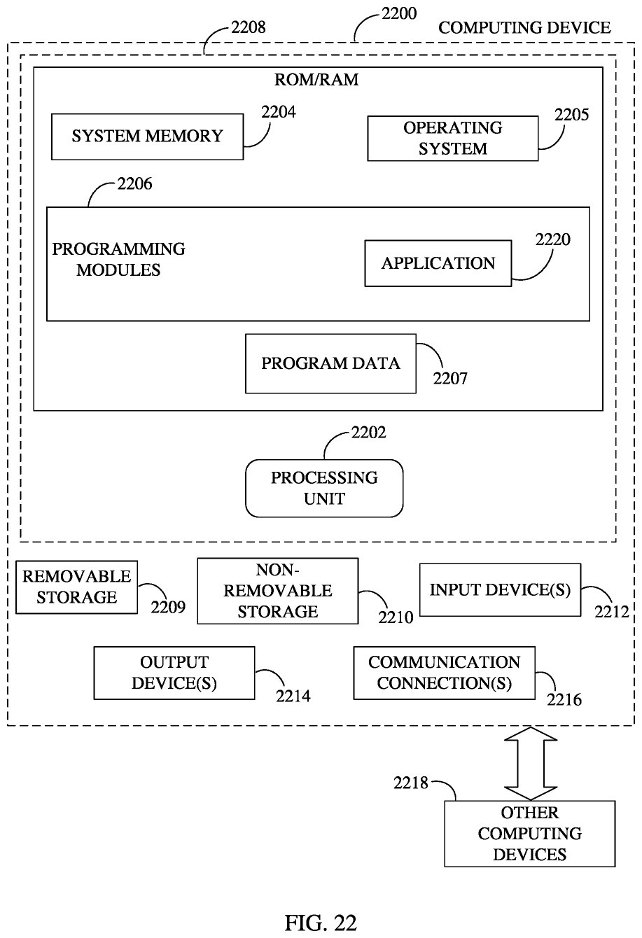

With reference to FIG. 22, a system consistent with an embodiment of the disclosure may include a computing device or cloud service, such as computing device 2200. In a basic configuration, computing device 2200 may include at least one processing unit 2202 and a system memory 2204. Depending on the configuration and type of computing device, system memory 2204 may comprise, but is not limited to, volatile (e.g., random-access memory (RAM)), non-volatile (e.g., read-only memory (ROM)), flash memory, or any combination. System memory 2204 may include operating system 2205, one or more programming modules 2206, and may include a program data 2207. Operating system 2205, for example, may be suitable for controlling computing device 2200's operation. In one embodiment, programming modules 2206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 22 by those components within a dashed line 2208.

Computing device 2200 may have additional features or functionality. For example, computing device 2200 may also include additional data storage devices (removable and/or non-removable) such as, for example, magnetic disks, optical disks, or tape. Such additional storage is illustrated in FIG. 22 by a removable storage 2209 and a non-removable storage 2210. Computer storage media may include volatile and non-volatile, removable and non-removable media implemented in any method or technology for storage of information, such as computer-readable instructions, data structures, program modules, or other data. System memory 2204, removable storage 2209, and non-removable storage 2210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2200. Any such computer storage media may be part of device 2200. Computing device 2200 may also have input device(s) 2212 such as a keyboard, a mouse, a pen, a sound input device, a touch input device, a location sensor, a camera, a biometric sensor, etc. Output device(s) 2214 such as a display, speakers, a printer, etc. may also be included. The aforementioned devices are examples and others may be used.

Computing device 2200 may also contain a communication connection 2216 that may allow device 2200 to communicate with other computing devices 2218, such as over a network in a distributed computing environment, for example, an intranet or the Internet. Communication connection 2216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2204, including operating system 2205. While executing on processing unit 2202, programming modules 2206 (e.g., application 2220 such as a media player) may perform processes including, for example, one or more stages of methods, algorithms, systems, applications, servers, databases as described above. The aforementioned process is an example, and processing unit 2202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure. Although the present disclosure has been explained in relation to its preferred embodiment, it is to be understood that many other possible modifications and variations can be made without departing from the spirit and scope of the disclosure.

What is claimed is:

1. A method for facilitating responding to queries associated with sporting events, the method comprising:
receiving, using a communication device, at least one query associated with at least one sporting event from at least one user device associated with at least one user, wherein the at least one query comprises at least one indication of the at least one sporting event;
analyzing, using a processing device, the at least one query using at least one natural language processing (NLP) model;
identifying, using the processing device, at least one intent associated with the at least one query and at least one parameter associated with the at least one intent based on the analyzing of the at least one query;
generating, using the processing device, at least one database query for the at least one query based on the at least one intent and the at least one parameter;
retrieving, using a storage device, at least one database associated with the at least one sporting event based on the at least one indication;
executing, using the processing device, at least one search in the at least one database based on the at least one database query;
generating, using the processing device, at least one search result for the at least one search based on the executing;
generating, using the processing device, at least one response for the at least one query using at least one natural language generation (NLG) model based on the at least one search result and the at least one query; and
transmitting, using the communication device, the at least one response to the at least one user device.

2. The method of claim 1 further comprising:
analyzing, using the processing device, the at least one intent based on the identifying;
determining, using the processing device, at least one parameter requirement for the at least one intent based on the analyzing of the at least one intent;
analyzing, using the processing device, the at least one parameter based on the at least one parameter requirement; and
determining, using the processing device, a fulfillment status for the at least one intent based on the analyzing of the at least one parameter, wherein the fulfillment status comprises a positive fulfillment status and a negative fulfillment status, wherein the generating of the at least one database query is further based on the positive fulfillment state.

3. The method of claim 2 further comprising:
generating, using the processing device, at least one prompt associated with the at least one query using the at least one NLG model based on the negative fulfillment status;
transmitting, using the communication device, the at least one prompt to the at least one user device;
receiving, using the communication device, at least one prompt response corresponding to the at least one prompt from the at least one user device;
analyzing, using the processing device, the at least one prompt response using the at least one NLP model;
identifying, using the processing device, at least one additional parameter for the at least one intent based on the analyzing of the at least one prompt response; and
analyzing, using the processing device, the at least one additional parameter based on the at least one parameter requirement, wherein the determining of the fulfillment status for the at least one intent is further based on the analyzing of the at least one additional parameter.

4. The method of claim 1 further comprising analyzing, using the processing device, the at least one search result and the at least one query using at least one machine learning model, wherein the generating of the at least one response is further based on the analyzing of the at least one search result and the at least one query.

5. The method of claim 4, wherein the at least one query comprises at least one assessment request associated with an occurrence of at least one future event in the at least one sporting event, wherein the method further comprises predicting, using the processing device, a probability of occurrence of the at least one future event in the at least one sporting event based on the analyzing of the at least one search result and the at least one query using the at least one machine learning model, wherein the at least one machine learning model is trained for predicting probability of occurrences for future events in the sporting events.

6. The method of claim 1, wherein the at least one user device comprises at least one microphone, wherein the at least one microphone is configured for generating at least one voice query based on receiving at least one voice input from the at least one user, wherein the at least one query comprises the at least one voice query.

7. The method of claim 1, wherein the at least one user device comprises at least one input device, wherein the at least one input device is configured for generating at least one textual query based on receiving at least one input from the at least one user, wherein the at least one query comprises the at least one textual query.

8. The method of claim 1, wherein the at least one user device is configured for generating the at least one query based on at least one input from the at least one user, wherein the at least one user device comprises at least one location sensor, wherein the at least one location sensor is configured for generating the at least one indication of the at least one sporting event based on detecting a location of the at least one user device, wherein the generating of the at least one query is further based on the generating of the at least one indication.

9. The method of claim 1, wherein the at least one response comprises at least one voice response, wherein the at least one user device comprises at least one speaker, wherein the at least one speaker is configured for presenting the at least one voice response.

10. The method of claim 1, wherein the at least one response comprises at least one visual response, wherein the at least one user device comprises at least one display device, wherein the at least one display device is configured for displaying the at least one visual response.

11. A system for facilitating responding to queries associated with sporting events, the system comprising:
a communication device configured for:
receiving at least one query associated with at least one sporting event from at least one user device associated with at least one user, wherein the at least one query comprises at least one indication of the at least one sporting event; and
transmitting at least one response to the at least one user device;
a processing device communicatively coupled with the communication device, wherein the processing device is configured for:
analyzing the at least one query using at least one natural language processing (NLP) model;
identifying at least one intent associated with the at least one query and at least one parameter associated with the at least one intent based on the analyzing of the at least one query;
generating at least one database query for the at least one query based on the at least one intent and the at least one parameter;
executing at least one search in at least one database based on the at least one database query;
generating at least one search result for the at least one search based on the executing; and
generating the at least one response for the at least one query using at least one natural language generation (NLG) model based on the at least one search result and the at least one query; and
a storage device communicatively coupled with the processing device, wherein the storage device is configured for retrieving the at least one database associated with the at least one sporting event based on the at least one indication.

12. The system of claim 11, wherein the processing device is further configured for:
analyzing the at least one intent based on the identifying;
determining at least one parameter requirement for the at least one intent based on the analyzing of the at least one intent;
analyzing the at least one parameter based on the at least one parameter requirement; and
determining a fulfillment status for the at least one intent based on the analyzing of the at least one parameter, wherein the fulfillment status comprises a positive fulfillment status and a negative fulfillment status, wherein the generating of the at least one database query is further based on the positive fulfillment state.

13. The system of claim 12, wherein the processing device is further configured for:
generating at least one prompt associated with the at least one query using the at least one NLG model based on the negative fulfillment status;
analyzing at least one prompt response using the at least one NLP model;
identifying at least one additional parameter for the at least one intent based on the analyzing of the at least one prompt response; and
analyzing the at least one additional parameter based on the at least one parameter requirement, wherein the determining of the fulfillment status for the at least one intent is further based on the analyzing of the at least one additional parameter, wherein the communication device is further configured for:
transmitting the at least one prompt to the at least one user device; and
receiving the at least one prompt response corresponding to the at least one prompt from the at least one user device.

14. The system of claim 11, wherein the processing device is further configured for analyzing the at least one search result and the at least one query using at least one machine learning model, wherein the generating of the at least one response is further based on the analyzing of the at least one search result and the at least one query.

15. The system of claim 14, wherein the at least one query comprises at least one assessment request associated with an occurrence of at least one future event in the at least one sporting event, wherein the processing device is further configured for predicting a probability of occurrence of the at least one future event in the at least one sporting event based on the analyzing of the at least one search result and the at least one query using the at least one machine learning model, wherein the at least one machine learning model is trained for predicting probability of occurrences for future events in the sporting events.

16. The system of claim 11, wherein the at least one user device comprises at least one microphone, wherein the at least one microphone is configured for generating at least one voice query based on receiving at least one voice input from the at least one user, wherein the at least one query comprises the at least one voice query.

17. The system of claim 11, wherein the at least one user device comprises at least one input device, wherein the at least one input device is configured for generating at least one textual query based on receiving at least one input from the at least one user, wherein the at least one query comprises the at least one textual query.

18. The system of claim 11, the at least one user device is configured for generating the at least one query based on at least one input from the at least one user wherein the at least one user device comprises at least one location sensor, wherein the at least one location sensor is configured for generating the at least one indication of the at least one sporting event based on detecting a location of the at least one user device, wherein the generating of the at least one query is further based on the generating of the at least one indication.

19. The system of claim 11, wherein the at least one response comprises at least one voice response, wherein the at least one user device comprises at least one speaker, wherein the at least one speaker is configured for presenting the at least one voice response.

20. The system of claim 11, wherein the at least one response comprises at least one visual response, wherein the at least one user device comprises at least one display device, wherein the at least one display device is configured for displaying the at least one visual response.
